(19) United States
(12) Patent Application Publication
(10) Pub. No.: US 2010/0220556 A1
(43) Pub. Date: Sep. 2, 2010

(54) Stepping motor control circuit and analog electronic watch

(76) Inventors: Kosuke Yamamoto, Chiba-shi (JP); Saburo Manaka, Chiba-shi (JP); Akira Takakura, Chiba-shi (JP); Kenji Ogasawara, Chiba-shi (JP); Kazumi Sakumoto, Chiba-shi (JP); Kazuo Kato, Chiba-shi (JP); Keishi Honmura, Chiba-shi (JP); Takanori Hasegawa, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/658,826

(22) Filed: Feb. 16, 2010

(30) Foreign Application Priority Data
Feb. 20, 2009 (JP) 2009-038142
Dec. 8, 2009 (JP) 2009-278879

(51) Int. Cl. G04B 19/04; H02P 8/38

(52) U.S. Cl. 368/80; 318/696

(57) ABSTRACT

A stepping motor control circuit includes a rotation detecting means which detects an induced signal generated by rotation of a rotor of a stepping motor, and detects a rotation state of the stepping motor according to whether the induced signal exceeds a predetermined reference threshold voltage in a predetermined detection section, and a control means which controls driving of the stepping motor by using any one of a plurality of main driving pulses having energies different from each other or a correction driving pulse having energy higher than energy of each main driving pulse according to a detection result of the rotation detecting means. The control means allows the main driving pulse to be down when a rotation state, in which an extra driving force of the main driving pulse is small, continuously occurs by a predetermined first number of times, and allows the main driving pulse to be down even if the rotation state having a small extra driving force does not continuously occur by the predetermined first number of times when a rotation state having a large extra driving force is large has occurred under a condition in which at least the rotation state having the small extra driving force continuously occurs.

### BACKGROUND OF THE INVENTION

1. Field of the Invention

The present invention relates to a stepping motor control circuit and an analog electronic watch using the same.

2. Description of the Related Art

In the related art, a stepping motor is used for an analog electronic watch and the like. The stepping motor includes a stator provided with a rotor receiving hole and a position determining portion for determining a stop position of a rotor, the rotor provided in the rotor receiving hole, and a coil. Further, the stepping motor rotates the rotor by magnetic flux generated in the stator by an alternating signal supplied to the coil, and stops the rotor at a position corresponding to the position determining portion.

As a control scheme for the stepping motor, there has been used a correction driving scheme in which, when the stepping motor is driven by a main driving pulse P11, it is detected whether the stepping motor is rotated by detecting an induced signal generated therein, and the main driving pulse P11 is changed to a main driving pulse P1 having a different pulse width for the driving of the stepping motor according to the detection result, or the stepping motor is forcibly rotated by a correction driving pulse P2 having a pulse width wider than that of the main driving pulse P11 (for example, refer to Japanese examined patent application publication No. 61-15385).

Further, in WO2005/119377, when detecting the rotation of the stepping motor, in addition to the detection of the induced signal, after a means is provided to compare a detection time with a reference time and the stepping motor is rotated by the main driving pulse P11, the correction driving pulse P2 is output if a detection signal is less than a predetermined reference threshold voltage Vcomp, and a next main driving pulse P1 is changed (pulse up) to a main driving pulse P12 with energy higher than that of the main driving pulse P11 so that the stepping motor is driven by the main driving pulse P12. If the detection time is earlier than the reference time when the stepping motor has been rotated by the main driving pulse P12, the main driving pulse P12 is changed (pulse down) to the main driving pulse P11, so that the stepping motor is rotated by the main driving pulse P1 according to a load during the driving thereof, resulting in reduction of current consumption.

However, in order to lower a pulse rank of the main driving pulse P1, the number of times of driving or the driving time in the main driving pulse P1 having the same energy is counted, and the rank of the main driving pulse P1 is down by one rank to narrow the pulse width after normal rotation driving by the main driving pulse P1 is performed by a predetermined number of times or for a predetermined time period.

When driving a calendar, during a calendar feed, a heavy calendar load is continuous for a constant time period in addition to a load (normal load) for driving time hands, and the calendar load returns to the normal load if the calendar feed is completed, so that a load is reduced. When a continuous load temporarily generated is reduced as in the case of the calendar load and the like, since a predetermined number of times or a predetermined time is continuously moved by the main driving pulse P1 having extra energy, driving energy may be wasted.

### SUMMARY OF THE INVENTION

It is an aspect of the invention to prevent the wasteful consumption of energy when a continuous load is reduced.

According to an aspect of the invention, a stepping motor control circuit includes: a rotation detecting means which detects an induced signal generated by rotation of a rotor of a stepping motor, and detects a rotation state of the stepping motor according to whether the induced signal exceeds a predetermined reference threshold voltage in a predetermined detection section; and a control means which controls driving of the stepping motor by using any one of a plurality of main driving pulses having energies different from each other or a correction driving pulse having energy higher than energy of each main driving pulse according to a detection result of the rotation detecting means, wherein the control means allows the main driving pulse to be down when a rotation state, in which an extra driving force of the main driving pulse is small, continuously occurs by a predetermined first number of times, and allows the main driving pulse to be down even if the rotation state having a small extra driving force does not continuously occur by the predetermined first number of times when a rotation state having a large extra driving force is large has occurred under a condition in which at least the rotation state having the small extra driving force continuously occurs.

Further, according to the invention, there is provided the stepping motor control circuit which includes the rotation detecting means, which detects the induced signal generated by rotation of the rotor of the stepping motor and detects the rotation state of the stepping motor according to whether the induced signal exceeds the predetermined reference threshold voltage in the predetermined detection section, and the control means which controls the driving of the stepping motor by using any one of the plurality of main driving pulses having energies different from each other or the correction driving pulse having energy higher than energy of each main driving pulse according to the detection result of the rotation detecting means. The control means counts the number of times of occurrences of the rotation state having the extra driving force as the number of times of occurrences, which is weighted according to the magnitude of the extra driving force. In the case in which the rotation state having the extra driving force has continuously occurred, when the sum of the number of times of occurrences, which is obtained by weighting the rotation states having the extra driving force, has reached a predetermined number of times, the control means allows the main driving pulse to be down.

In addition, according to the invention, there is provided an analog electronic watch including a stepping motor for rotating time hands and a stepping motor control circuit for controlling the stepping motor, wherein the above-described stepping motor control circuit is used as the stepping motor control circuit.

According to the motor control circuit of the invention, when a continuous load is reduced, the wasteful consumption of energy can be prevented.

In addition, according to the analog electronic watch of the invention, when the continuous load such as a calendar load is reduced, the wasteful consumption of energy can be prevented.

### BRIEF DESCRIPTION OF THE DRAWINGS

FIG. 1 is a block diagram illustrating a stepping motor control circuit and an analog electronic watch according to an embodiment of the invention;

FIG. 2 is a diagram illustrating the configuration of a stepping motor used for an analog electronic watch according to an embodiment of the invention;

FIG. 3 is a timing diagram illustrating the operations of a stepping motor control circuit and an analog electronic watch according to an embodiment of the invention;

FIG. 4 is a determination chart illustrating the operations of a stepping motor control circuit and an analog electronic watch according to an embodiment of the invention;

FIG. 5 is a flowchart illustrating the operations of a stepping motor control circuit and an analog electronic watch according to an embodiment of the invention;

FIG. 6 is a diagram illustrating the configuration of a driving mechanism of a general calendar display unit;

FIG. 7 is a timing diagram illustrating the operations of a stepping motor control circuit and an analog electronic watch according to another embodiment of the invention;

FIG. 8 is a timing diagram illustrating the operations of a stepping motor control circuit and an analog electronic watch according to another embodiment of the invention;

FIG. 9 is a timing diagram illustrating the operations of a stepping motor control circuit and an analog electronic watch according to another embodiment of the invention;

FIG. 10 is a determination chart illustrating the operations of a stepping motor control circuit and an analog electronic watch according to another embodiment of the invention; and

FIG. 11 is a flowchart illustrating the operations of a stepping motor control circuit and an analog electronic watch according to another embodiment of the invention.

### DETAILED DESCRIPTION OF THE INVENTION

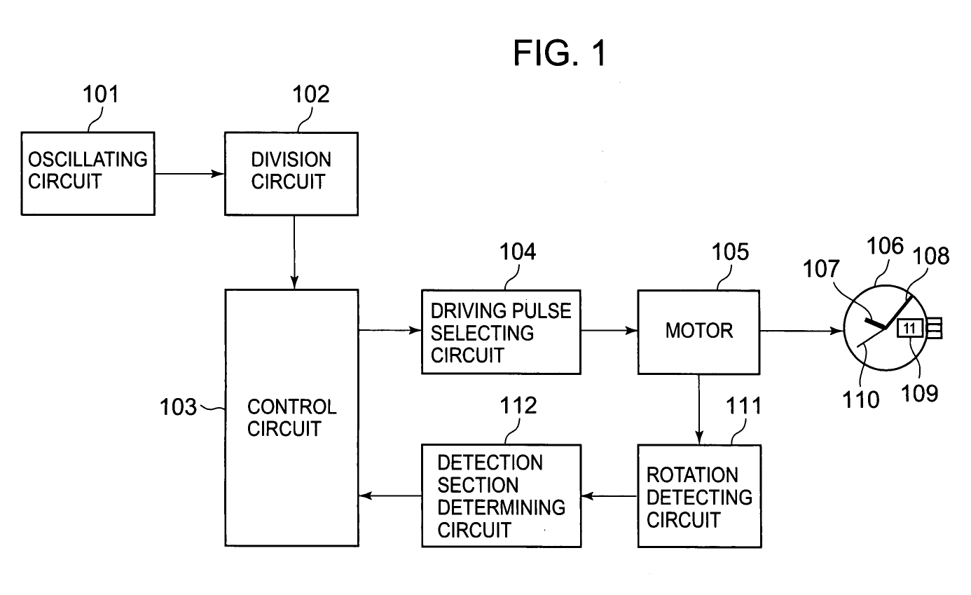

FIG. 1 is a block diagram illustrating an analog electronic watch using a motor control circuit according to an embodiment of the invention, which illustrates an example of an analog electronic wrist watch.

In FIG. 1, the analog electronic watch includes an oscillating circuit 101 for generating a signal with a predetermined frequency, a divider circuit 102 for dividing the signal generated by the oscillating circuit 101 to generate a watch signal serving as a reference of a watch, a control circuit 103 for controlling electronic circuit elements constituting the electronic watch or controlling the change of a driving pulse, a driving pulse selecting circuit 104 for selecting and outputting a driving pulse for driving the rotation of a motor based on a control signal from the control circuit 103, a stepping motor 105 rotated by the driving pulse from the driving pulse selecting circuit 104, and an analog display unit 106 provided with both time hands (in the example of FIG. 1, three types of time hands, that is, an hour hand 107, a minute hand 108 and a second-hand 110), which are rotated by the stepping motor 105 to display a time, and a calendar display portion 109 for displaying a date.

Further, the analog electronic watch includes a rotation detecting circuit 111 for detecting an induced signal VRs representing a rotation state of the stepping motor 105 in a predetermined detection section T, and a detection section determining circuit 112 for determining a detection section of the induced signal VRs by performing a comparison operation based on a time and a section at which the rotation detecting circuit 111 has detected the induced signal VRs exceeding a predetermined reference threshold voltage Vcomp. As described later, the detection section T, which is used for detecting whether the stepping motor 105 has been rotated, is divided into a plurality of sections (in the present embodiment, three sections as described later).

The rotation detecting circuit 111 is configured to detect the induced signal VRs by using the same principle as that of a rotation detecting circuit according to Japanese examined patent application publication No. 61-15385. When a rotation operation is performed at a high speed as in the case in which the stepping motor 105 is rotated, the induced signal VRs exceeding the predetermined reference threshold voltage Vcomp is generated. When a rotation operation is performed at a low speed as in the case in which the motor 105 is not rotated, the predetermined reference threshold voltage Vcomp is set such that the induced signal VRs does not exceed the reference threshold voltage Vcomp.

Further, the oscillating circuit 101 and the divider circuit 102 constitute a signal generating means, and the analog display unit 106 constitutes a time display means. The rotation detecting circuit 111 constitutes a rotation detecting means, and the control circuit 103, the driving pulse selecting circuit 104, the rotation detecting circuit 111 and the detection section determining circuit 112 constitute a control means.

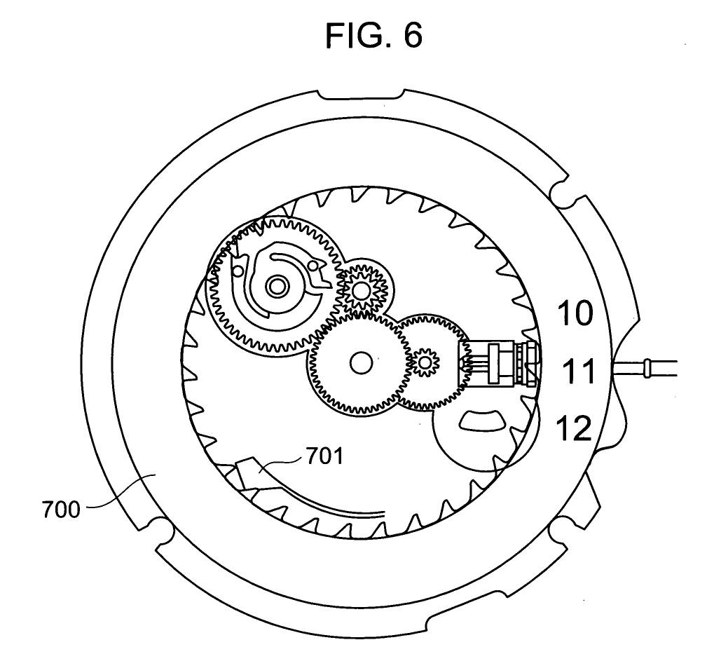

FIG. 6 is a diagram illustrating the configuration of a driving mechanism of the calendar display portion 109 of the analog display unit 106. In FIG. 6, the calendar display portion 109 includes a date indicator 700 with a date, and a jump control lever 701 for controlling movement of the date indicator 700 such that a date is displayed on a date display window. If a predetermined time is reached every day, the control circuit 103 drives the stepping motor 105 to rotate the date indicator 700, so that a date feed operation is performed. When the date feed operation is performed, since the date indicator 700 is rotated against the control force of the jump control lever 701, a heavy load is required. The state before the date feed operation denotes a normal load state in which only the time hands are driven, and the state until date feed is completed after the date feed operation is performed denotes a continuous load state in which a state of (the normal load+a constant load) is continued for a constant time period. If the date feed operation is completed, since the loads of the jump control lever 701 and the date indicator 700 are reduced, it returns to the normal load state in which only the time hands are driven.

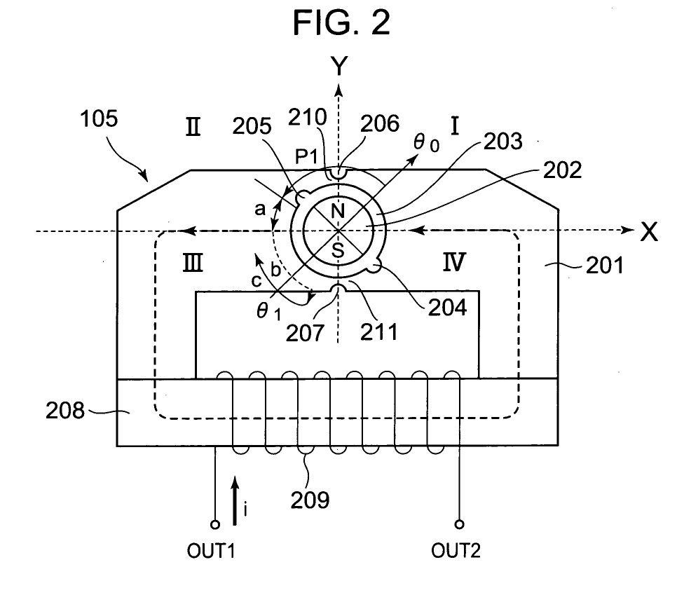

FIG. 2 is a diagram illustrating the configuration of the stepping motor 105 used for the embodiment of the invention, which illustrates an example of a watch stepping motor generally used for an analog electronic watch.

In FIG. 2, the stepping motor 105 includes a stator 201 formed with a rotor receiving through hole 203, a rotor 202 rotatably provided in the rotor receiving through hole 203, a magnetic core 208 bonded to the stator 201, and a coil 209 wound around the magnetic core 208. When the stepping motor 105 is used for an analog electronic watch, the stator 201 and the magnetic core 208 are fixed to a ground plane (not shown) by screws (not shown) while being bonded to each other. The coil 209 has a primary terminal OUT1 and a secondary terminal OUT2.

The rotor 202 is magnetized to two poles (S and N poles). The stator 201 made of a magnetic material is formed at the outer end portion thereof with a plurality (two in the present embodiment) of cutout parts (outer notches) 206 and 207 which face each other while interposing the rotor receiving through hole 203 therebetween. Saturable parts 210 and 211 are provided between each of the notches 206 and 207 and the rotor receiving through hole 203.

The saturable parts 210 and 211 are not saturated by the magnetic flux of the rotor 202, but are saturated when the coil 209 is excited so that magnetic resistance becomes large. The rotor receiving through hole 203 is formed in circular hole shape in which a plurality (two in the present embodiment) of semilunar cutout parts (inner notches) 204 and 205 are integrally formed with each other at opposite positions of the through hole which is circular in outline.

The cutout parts 204 and 205 serve as position determining portions for determining a stop position of the rotor 202. In the state in which the coil 209 is not excited, the rotor 202 is stably stopped at a position corresponding to the position determining portions as illustrated in FIG. 2, in other words, a magnetic pole axis of the rotor 202 is stably stopped at a position (position of an angle of θ0) which is perpendicular to a line segment which connects the cutout part 204 to the cutout part 205. An XY coordinate space, in which a rotation axis (rotation center) of the rotor 202 is employed as a center, is divided into four quadrants (first to fourth quadrants I to IV).

If an electric current i flows in the arrow direction of FIG. 2 by a rectangular waveform driving pulse supplied between the terminals OUT1 and OUT2 of the coil 209 from the driving pulse selecting circuit 104 (e.g., the primary terminal OUT1 is referred to as a positive pole and the secondary terminal OUT2 is referred to as a negative pole), magnetic flux is generated in the stator 201 in the broken line arrow direction. Therefore, the saturable parts 210 and 211 are saturated so that magnetic resistance becomes large. Thereafter, due to an interaction between magnetic poles generated in the stator 201 and the magnetic poles of the rotor 202, since the rotor 202 is rotated at an angle of 180° in the arrow direction of FIG. 2, the magnetic pole axis of the rotor 202 is stably stopped at a position of an angle of θ1. Herein, the rotation direction (the counterclockwise direction in FIG. 2), in which a normal operation (a hand moving operation in the analog electronic watch of the present embodiment) is performed by the rotation of the stepping motor 105, will be referred to as the forward direction, and the opposite (the clockwise direction) will be referred to as the backward direction.

Next, if an electric current flows in the opposite arrow direction of FIG. 2 by a rectangular waveform driving pulse having a reverse polarity supplied between the terminals OUT1 and OUT2 of the coil 209 from the driving pulse selecting circuit 104 (the primary terminal OUT1 is referred to as a negative pole and the secondary terminal OUT2 is referred to as a positive pole such that reverse polarity occurs as compared with the above driving), magnetic flux is generated in the stator 201 in the direction opposite to the broken line arrow direction. Therefore, the saturable parts 210 and 211 are first saturated. Thereafter, due to the interaction between the magnetic poles generated in the stator 201 and the magnetic poles of the rotor 202, since the rotor 202 is rotated at the angle of 180° in the same direction (forward direction) as that in the above case, the magnetic pole axis of the rotor 202 is stably stopped at a position of the angle of θ0.

Then, the above operation is repeated by supplying the coil 209 with signals (alternating signals) having different polarities, so that the rotor 202 can be continuously rotated by 180° in the arrow direction. According to the present embodiment, as described later, a plurality of main driving pulses P10 to P1n having different energies and a correction driving pulse P2 are used as the driving pulse.

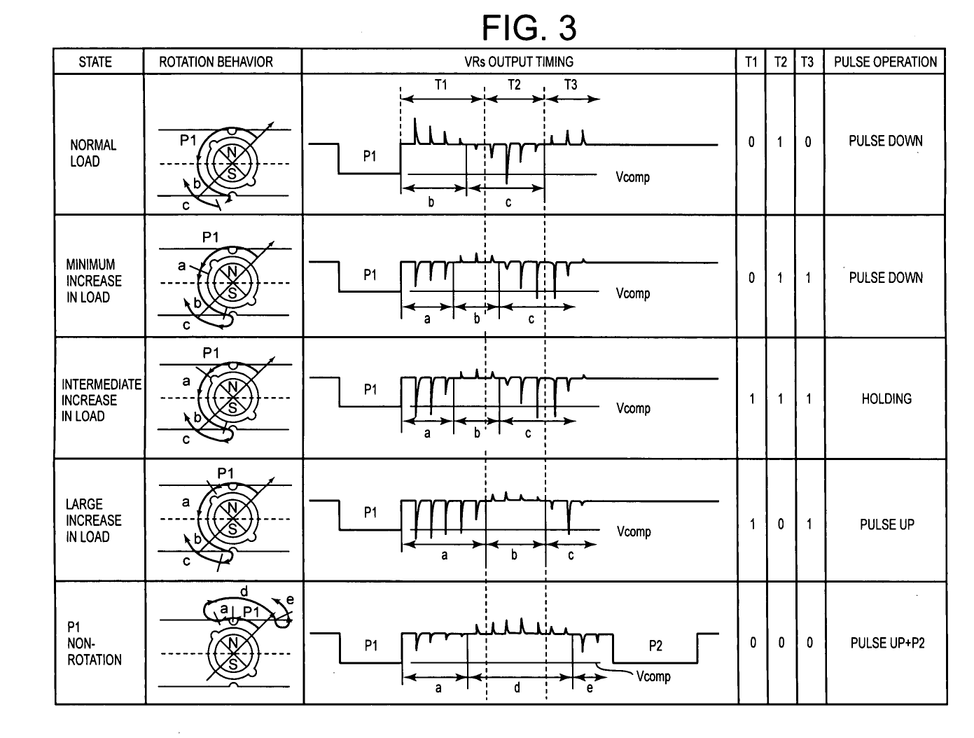

FIG. 3 is a timing diagram when the stepping motor 105 is driven by the main driving pulse P1 according to the present embodiment, which collectively illustrates the magnitude of a load, the rotation position of the rotor 202, a pattern representing a rotation state and a pulse control operation.

In FIG. 3, P1 denotes both the main driving pulse P1 and a section in which the rotor 202 is rotated by the main driving pulse P1, and “a” to “e” denote regions representing the rotation positions of the rotor 202 by free vibration after driving of the main driving pulse P1 is stopped.

A predetermined time immediately after driving by the main driving pulse P1 is defined as a first section T1, a predetermined time after the first section T1 is defined as a second section T2, and a predetermined time after the second section T2 is defined as a third section T3. In this way, the entire detection section T starting from immediately after the driving by the main driving pulse P1 is divided into a plurality of sections (in the present embodiment, three sections T1 to T3). However, in the present embodiment, a mask section, in which the induced signal VRs is not detected, is not provided.

When the rotor 202 is employed as the center and the XY coordinate space, in which the main magnetic pole of the rotor 202 is located by the rotation thereof, is divided into the first to fourth quadrants I to IV, the first to third sections T1 to T3 can be defined as follows.

That is, in a state of a normal load, the first section T1 serves as a section for detecting the initial rotation state of the rotor 202 in the backward direction from the rotation state of the rotor 202 in the forward direction (direction in which the rotor 202 is rotated) in the third quadrant III of the space employing the rotor 202 as the center, the second section T2 serves as a section for detecting the initial rotation state of the rotor 202 in the backward direction in the third quadrant III, and the third section T3 serves as a section for detecting the rotation state after the initial rotation of the rotor 202 in the backward direction in the third quadrant III. Herein, the normal load means a load driven in a normal time. According to the present embodiment, a load when driving the time hands (the hour hand 107, the minute hand 108 and the second-hand 110) is defined as the normal load.

Further, in a state in which a slightly small load is added to the normal load (i.e., increase in a load is minimal), the first section T1 serves as a section for detecting a rotation state of the rotor 202 in the forward direction in the second quadrant II and an initial rotation state of the rotor 202 in the forward direction in the third quadrant III, the second section T2 serves as a section for detecting the initial rotation state of the rotor 202 in the forward direction and the initial rotation state of the rotor 202 in the backward direction in the third quadrant III, and the third section T3 serves as a section for detecting a rotation state after the initial rotation of the rotor 202 in the backward direction in the third quadrant III.

The Vcomp serves as a reference threshold voltage for determining a voltage level of the induced signal VRs generated in the stepping motor 105. When the rotor 202 performs a constant high speed operation as in the case in which the stepping motor 105 is rotated, the induced signal VRs exceeds the reference threshold voltage Vcomp. When the rotor 202 does not perform the constant high speed operation as in the case in which the stepping motor 105 is not rotated, the reference threshold voltage Vcomp is set such that the induced signal VRs does not exceed the reference threshold voltage Vcomp.

For example, referring to FIG. 3, in the stepping motor control circuit according to the present embodiment, in the state of the normal load, the induced signal VRs generated in the area “b” is detected in the first section T1, the induced signal VRs generated in the area “c” is detected in the first section T1 and the second section T2, and the induced signal VRs generated after the area “c” is detected in the third section T3.

If a determination value “1” is given when the rotation detecting circuit 111 detects the induced signal VRs exceeding the reference threshold voltage Vcomp, and a determination value “0” is given when the rotation detecting circuit 111 cannot detect the induced signal VRs exceeding the reference threshold voltage Vcomp, in the example of the normal load driving of FIG. 3, (0, 1, 0) is generated as a pattern (including a determination value of the first section T1, a determination value of the second section T2 and a determination value of the third section T3) representing a rotation state, and the control circuit 103 determines that the driving energy is in enough excess (e.g., surplus rotation) to perform pulse control such that the driving energy of the main driving pulse P1 is down (pulse down) by one rank.

Further, in a state of minimum increase in a load, the induced signal VRs generated in the area “a” is detected in the first section T1, the induced signal VRs generated in the area “b” is detected in the first section T1 and the second section T2, and the induced signal VRs generated after the area “c” is detected in the second section T2 and the third section T3. In the example of FIG. 3, a pattern (0, 1, 1) is obtained, and the control circuit 103 determines that the surplus rotation occurs similarly to the above case to perform the pulse control such that the driving energy of the main driving pulse P1 is down by one rank.

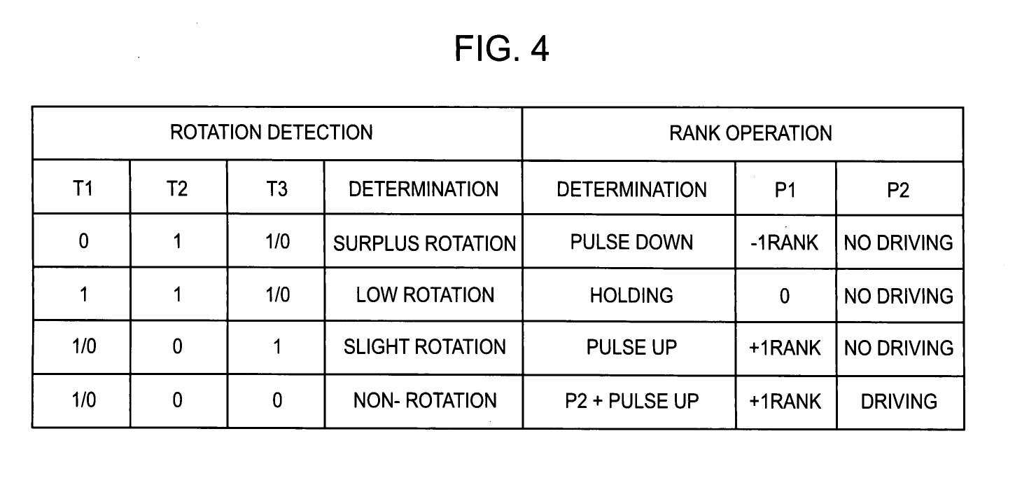

FIG. 4 is a determination chart obtained by collecting operations according to the present embodiment. In FIG. 4, as described above, the determination value “1” is given when the induced signal VRs exceeding the reference threshold voltage Vcomp is detected, and the determination value “0” is given when the induced signal VRs exceeding the reference threshold voltage Vcomp cannot be detected. Further, “1/0” represents that the determination values may have “1” or “0”.

As illustrated in FIG. 4, the rotation detecting circuit 111 detects the existence of the induced signal VRs exceeding the reference threshold voltage Vcomp, and the control circuit 103 and the driving pulse selecting circuit 104 control the rotation of the stepping motor 105 by performing driving pulse control, which will be described later, such as pulse up or pulse down of the main driving pulse P1, or driving based on the correction driving pulse P2 based on the pattern, by which the detection section determining circuit 112 determines the detection time of the induced signal VRs, with reference to the determination chart of FIG. 4 stored in the control circuit 103.

For example, in the case of a pattern (1/0, 0, 0), the control circuit 103 determines that the stepping motor 105 is not rotated (e.g., non-rotation), and controls the driving pulse selecting circuit 104 such that the stepping motor 105 is driven by the correction driving pulse P2. Thereafter, the control circuit 103 controls the driving pulse selecting circuit 104 such that the stepping motor 105 is driven by the main driving pulse P1 changed through one rank up (pulse up) in the next driving.

In the case of a pattern (1/0, 0, 1), the control circuit 103 determines that the stepping motor 105 is rotated but the non-rotation may occur in the next driving (e.g., slight rotation) because the current state is a state in which a heavy load is added to the normal load (e.g., large increase in a load), and controls the driving pulse selecting circuit 104 in advance such that the stepping motor 105 is driven by the main driving pulse P1 changed through one rank up in the next driving, without performing the driving by the correction driving pulse P2.

In the case of a pattern (1, 1, 1/0), the control circuit 103 determines that the stepping motor 105 is rotated, the current state is a state in which an intermediate load is added to the normal load (e.g., during the increase in a load), an extra driving force exists, and driving energy is sufficient (e.g., low rotation), and then controls the driving pulse selecting circuit 104 such that the stepping is 105 is driven without changing the main driving pulse P1 until the pattern continuously occurs by a predetermined number of times.

In the case of a pattern (0, 1, 1/0), the control circuit 103 determines that the stepping motor 105 is rotated, the load is the normal load or increase in the load is minimum, and the driving energy is left (e.g., surplus rotation), and controls the driving pulse selecting circuit 104 such that the stepping motor 105 is driven by the main driving pulse P1 changed through one rank down in the next driving.

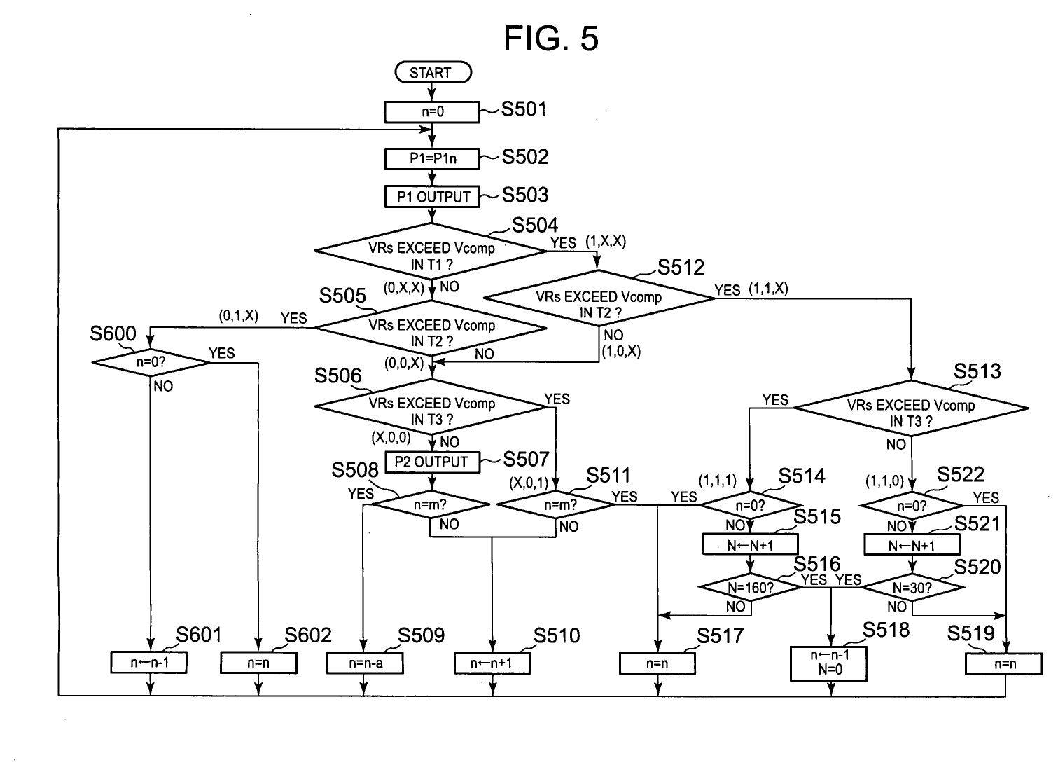

FIG. 5 is a flowchart illustrating the operations of the stepping motor control circuit and the analog electronic watch according to the embodiment of the invention, which is a flowchart mainly illustrating the processing of the control circuit 103.

Hereinafter, the operations of the stepping motor control circuit and the analog electronic watch according to the embodiment of the invention will be described in detail with reference to FIGS. 1 to 6.

In FIG. 1, the oscillating circuit 101 generates a reference clock signal with a predetermined frequency, and the divider circuit 102 divides the signal generated by the oscillating circuit 101 to generate the watch signal serving as the reference of the watch, and outputs the watch signal to the control circuit 103.

The control circuit 103 performs a time counting operation by counting the watch signal. First, the control circuit 103 sets a rank “n” of the main driving pulse P1n and the number N of times, by which a rotation state having an extra driving force continuously occurs, to “0” (Step S501 of FIG. 5), and outputs a control signal such that the stepping motor 105 is rotated by the main driving pulse P10 with a minimum pulse width (Steps S502 and S503).

The driving pulse selecting circuit 104 rotates the stepping motor 105 by using the main driving pulse P10 in response to the control signal from the control circuit 103. The stepping motor 105 is rotated by the main driving pulse P10 to rotate the time hands 107, 108 and 110. In this way, when the stepping motor 105 is normally rotated, the current time is displayed at any time on the analog display unit 106 through the time hands 107, 108 and 110.

The control circuit 103 determines whether the rotation detecting circuit 111 has detected the induced signal VRs of the stepping motor 105 exceeding the predetermined reference threshold voltage Vcomp, and determines whether the detection section determining circuit 112 has decided that the detection time t of the induced signal VRs belongs to the section T1 (i.e., determines whether the induced signal VRs exceeding the reference threshold voltage Vcomp has been detected in the first section T1) (Step S504). When it is determined that the induced signal VRs exceeding the reference threshold voltage Vcomp has not been detected in the first section T1 in the process step S504 (in the case of a pattern expressed by (0, x, x) and the determination value “x” may be “1” or “0”), the control circuit 103 determines whether the induced signal VRs exceeding the reference threshold voltage Vcomp has been detected in the second section T2 similarly to the above method (Step S505).

When it is determined that the induced signal VRs exceeding the reference threshold voltage Vcomp has not been detected in the second section T2 in the process step S505 (in the case of a pattern expressed by (0, 0, x)), the control circuit 103 determines whether the induced signal VRs exceeding the reference threshold voltage Vcomp has been detected in the third section T3 similarly to the above method (Step S506).

When it is determined that the induced signal VRs exceeding the reference threshold voltage Vcomp has not been detected in the third section T3 in the process step S506 (in the case of a pattern expressed by (x, 0, 0) and the non-rotation of FIGS. 3 and 4), the control circuit 103 drives the stepping motor 105 by the correction driving pulse P2 (Step S507). When the rank “n” of the main driving pulse P1 is not the maximum rank “m” (Step S508), the control circuit 103 allows the rank of the main driving pulse P1 to be up by one rank to obtain a main driving pulse P1 (n+1), and then returns to the process step S502. In the next driving, the control circuit 103 drives the stepping motor 105 by the main driving pulse P1 (n+1) (Steps S508 and S510).

When the rank “n” of the main driving pulse P1 is the maximum rank “m” in the process step S508, the control circuit 103 changes the main driving pulse P1 to a main driving pulse P1 (n-a) with predetermined low energy and then returns to the process step S502. In the next driving, the control circuit 103 drives the stepping motor 105 by the main driving pulse P1 (n-a) (Step S509). In such a case, since there exists a state in which the rotation of the stepping motor 105 is impossible even if a driving pulse P1m with the maximum energy of the main driving pulse P1 is used, it is possible to reduce wastefulness of energy caused by the driving by the driving pulse P1m with the maximum energy in the next driving. At this time, in order to achieve significant power-saving effect, the main driving pulse P1 may be changed to the main driving pulse P10 with the minimum energy.

When it is determined that the induced signal VRs exceeding the reference threshold voltage Vcomp has been detected in the third section T3 in the process step S506 (in the case of a pattern expressed by (x, 0, 1)), if the rank “n” of the main driving pulse P1 is not the maximum rank “m”, the control circuit 103 allows the rank of the main driving pulse P1 to be up by one rank to obtain the main driving pulse P1 (n+1), and then returns to the process step S502. In the next driving, the control circuit 103 drives the stepping motor 105 by the main driving pulse P1 (n+1) (Steps S511 and S510; the case of the large increase in the load of FIG. 3 or the case of the slight rotation of FIG. 4).

When the rank “n” of the main driving pulse P1 is the maximum rank “m” in the process step S511, since it is not necessary to change the rank, the control circuit 103 returns to the process step S502 without changing the main driving pulse P1, and then drives the stepping motor 105 by the main driving pulse P1 in the next driving (Step S517).

When it is determined that the induced signal VRs exceeding the reference threshold voltage Vcomp has been detected in the first section T1 in the process step S504 (in the case of a pattern expressed by (1, x, x)), the control circuit 103 determines whether the induced signal VRs exceeding the reference threshold voltage Vcomp has been detected in the second section T2 similarly to the above method (Step S512).

When it is determined that the induced signal VRs exceeding the reference threshold voltage Vcomp has not been detected in the second section T2 in the process step S512 (in the case of a pattern expressed by (1, 0, x)), the control circuit 103 performs the process step S506.

When it is determined that the induced signal VRs exceeding the reference threshold voltage Vcomp has been detected in the second section T2 in the process step S512 (in the case of a pattern expressed by (1, 1, x)), the control circuit 103 determines whether the induced signal VRs exceeding the reference threshold voltage Vcomp has been detected in the third section T3 similarly to the above method (Step S513).

When it is determined that the induced signal VRs exceeding the reference threshold voltage Vcomp has been detected in the third section T3 in the process step S513 (in the case of a pattern expressed by (1, 1, 1) and a rotation state having an extra driving force smaller than a predetermined value, and in the case of during the increase in the load of FIG. 3 and the low rotation of FIG. 4), if the rank “n” of the main driving pulse P1 is the minimum rank “0”, since it is not necessary to lower the rank, the control circuit 103 maintains the rank without changing the rank and returns to the process step S502 (Steps S514 and S517).

When it is determined that the rank “n” of the main driving pulse 91 is not the minimum rank “0” in the process step S514, the control circuit 103 adds 1 to the number N of times of continuous occurrences (Step S515), and determines whether the number N of times has reached a predetermined first number of times (in the present embodiment, 160 times) (Step S516). When it is determined that the number N of times has not reached the predetermined first number of times, the control circuit 103 returns to the process step S502 without changing the rank of the main driving pulse 91 (Step S517). When it is determined that the number N of times has reached the predetermined first number of times, the control circuit 103 allows the rank of the main driving pulse P1 to be down by one rank while resetting the number N of times of continuous occurrences to “0”, and then returns to the process step S502 (Step S518).

As described above, in the case in which the pattern representing the rotation state of during the increase in the load is the pattern (1, 1, 1) representing that the extra driving force is small, when the pattern has been continuously generated by a predetermined number of times, that is, when the low rotation has continuously occurred by the first number of times, the control circuit 103 performs the pulse down if it is determined that the stepping motor 105 can be stably rotated through the pulse down, but does not perform the pulse down, which may cause non-rotation, for the purpose of achieving power saving.

When it is determined that the induced signal VRs exceeding the reference threshold voltage Vcomp has not been detected in the third section T3 in the process step S513 (in the case of a pattern expressed by (1, 1, 0) and a rotation state having an extra driving force larger than the predetermined value, and in the case of the low rotation of FIG. 4), if the rank “n” of the main driving pulse P1 is the minimum rank “0”, since it is not necessary to lower the rank, the control circuit 103 returns to the process step S502 without changing the rank (Steps S522 and S519).

When it is determined that the rank “n” of the main driving pulse P1 is not the minimum rank “0” in the process step S522, the control circuit 103 adds 1 to the number N of times of continuous occurrences (Step S521), and determines whether the number N of times has reached a predetermined second number of times (in the present embodiment, 30 times) smaller that the predetermined first number of times (Step S520). When it is determined that the number N of times has not reached the second number of times, the control circuit 103 returns to the process step S502 without changing the rank of the main driving pulse P1 (Step S519). When it is determined that the number N of times has reached the second number of times, the control circuit 103 allows the rank of the main driving pulse P1 to be down by one rank while resetting the number N of times of continuous occurrences to “0”, and then returns to the process step S502 (Step S518). The example of this operation denotes a case in which, after the calendar load serving as a continuous load is driven, the driving of the calendar load is completed, so that the load is reduced because only the time hands are driven.

As described above, when the pattern representing that the extra driving force is small has been continuously generated by the predetermined first number of times, the main driving pulse is allowed to be down. When the pattern representing that the extra driving force is large has been generated under the condition in which at least the pattern representing that the extra driving force is small is continuously generated, the main driving pulse P1 is allowed to be down even before the pattern representing that the extra driving force is small is continuously generated by the first number of times. Further, under the condition in which at least the rotation state having the small extra driving force continuously occurs, when the rotation state having the large extra driving force has occurred, if the sum of the number of times, by which the rotation state having the small extra driving force continuously occurs, and the number of times, by which the rotation state having the large extra driving force continuously occurs, has reached the second number of times which is smaller than the first number of times, the main driving pulse P1 is allowed to be down.

Thus, according to the stepping motor control circuit and the analog electronic watch of the present embodiment, in the case in which a stable operation is performed due to the extra driving force, since the pulse down can be quickly performed, when the continuous load understood in advance is reduced, the wasteful consumption of energy can be prevented.

Further, the reduction of the load is detected and the pulse width of the main driving pulse P1 is narrowed, so that the pulse down is performed in response to the load reduction and low power consumption can be achieved without the wasteful consumption of energy.

Meanwhile, when it is determined that the induced signal VRs exceeding the reference threshold voltage Vcomp has been detected in the second section T2 in the process step S505 (in the case of a pattern expressed by (0, 1, x) and in the case of the surplus rotation in the normal load and the minimum increase in the load of FIG. 3 and the surplus rotation of FIG. 4), if the rank “n” of the main driving pulse P1 is the minimum rank “0”, since it is not necessary to lower the rank, the control circuit 103 returns to the process step S502 without changing the rank (Steps S600 and S602). If the rank “n” of the main driving pulse P1 is not the minimum rank “0”, the control circuit 103 immediately allows the main driving pulse P1 to be down by one rank and returns to the process step S502 (Steps S600 and S601). In this way, when the extra driving force is further large, the main driving pulse P1 is immediately allowed be down, so that the stable driving is maintained and power saving can be achieved.

Further, under the condition in which at least the rotation state having the small extra driving force continuously occurs, when the rotation state having the large extra driving force has occurred, if the sum of the number N of times, by which the rotation state having the small extra driving force continuously occurs, and the number N of times, by which the rotation state having the large extra driving force continuously occurs, has reached the second number of times which is smaller than the first number of times, the control means can allow the main driving pulse P1 to be down.

In addition, the detection section T is divided into the first section T1 immediately after driving by the main driving pulse, the second section T2 after the first section T1, and the third section T3 after the second section T2, and, in a normal load state, the first section T1 serves as a section for determining a rotation state of the rotor 202 in the forward direction and an initial rotation state of the rotor 202 in the backward direction in a third quadrant III of a space employing the rotor 202 as a center, the second section T2 serves as a section for determining the initial rotation state of the rotor 202 in the backward direction in the third quadrant III, and the third section T3 serves as a section for determining a rotation state after the initial rotation of the rotor 202 in the backward direction in the third quadrant III. When the pattern representing that the extra driving force is small has been continuously generated by the first number of times, the control means can allow the main driving pulse P1 to be down. When the pattern representing that the extra driving force is large has been generated under the condition in which at least the pattern representing that the extra driving force is small is continuously generated, even if the pattern representing that the extra driving force is small is not continuously generated by the first number of times, the control means can allow the main driving pulse P1 to be down.

Furthermore, the pattern representing that the extra driving force is small can be expressed by (1, 1, 1) and the pattern representing that the extra driving force is large can be expressed by (1, 1, 0).

Moreover, when the pattern (0, 1, x) representing that the extra driving force is further large has been generated, the control means can immediately allow the main driving pulse to be down.

Furthermore, the analog electronic watch according to the present embodiment includes a stepping motor for rotating time hands and a stepping motor control circuit for controlling the stepping motor, and is characterized in that the above-described stepping motor control circuit is used as the stepping motor control circuit. Further, the analog electronic watch includes a date indicator for displaying dates. Herein, a period for which the stepping motor drives the date indicator can represent a rotation state in which an extra driving force is small, and a period after the driving of the date indicator is completed can represent a rotation state in which the extra driving force is large.

Hereinafter, a stepping motor control circuit and an analog electronic watch according to another embodiment of the invention will be described. A block diagram according to another embodiment is identical to the block diagram illustrated in FIG. 1, and a stepping motor used has the configuration illustrated in FIG. 2.

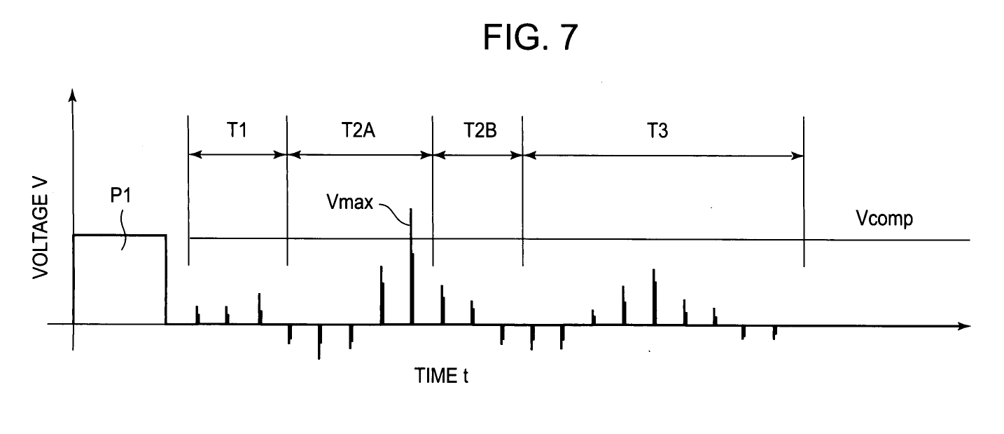

FIGS. 7 to 9 are timing charts illustrating operations according to another embodiment of the invention. In the previous embodiment, the detection section T is divided into the three sections T1 to T3. However, according to another embodiment, the section T2 of the previous embodiment is divided into two sections T2A and T2B, and the sections T1 and T3 are identical to those of the previous embodiment, so that the detection section T is divided into the four sections T1, T2A, T2B and T3.

That is, according to another embodiment, the detection section T is divided into a plurality of sections, for example, the first section T1 (identical to the first section of the previous embodiment) immediately after driving by the main driving pulse P1, the second section T2A after the first section T1, the third section T2B after the second section T2A, and the fourth section T3 (identical to the third section of the previous embodiment) after the third section T2B.

In a normal load state, the first section T1 serves as a section for determining a rotation state of the rotor 202 in the forward direction and an initial rotation state of the rotor 202 in the backward direction in a third quadrant III of a space employing the rotor 202 as a center, the second section T2A and the third section T2B serve as sections for determining the initial rotation state of the rotor 202 in the backward direction in the third quadrant III, and the fourth section T3 serves as a section for determining a rotation state after the initial rotation of the rotor 202 in the backward direction in the third quadrant III.

Further, it is preferred that the third section T2B has a time width which is enough to detect at least one induced signal VRs. That is, it is preferred that the third section T2B has a time width corresponding to one period in which the rotation detecting circuit 111 samples the induced signal VRs.

In FIG. 7, the maximum value Vmax of the induced signal VRs exceeding the reference threshold voltage Vcomp is detected only in the second section T2A, and a pattern (0, 1, 0, 0) is generated as a pattern (the first section T1, the second section T2A, the third section T2B and the fourth section T3). Such a case represents a rotation state having an extra driving force. Further, such a case represents a rotation state in which the extra driving force is large and rotation margin is the maximum.

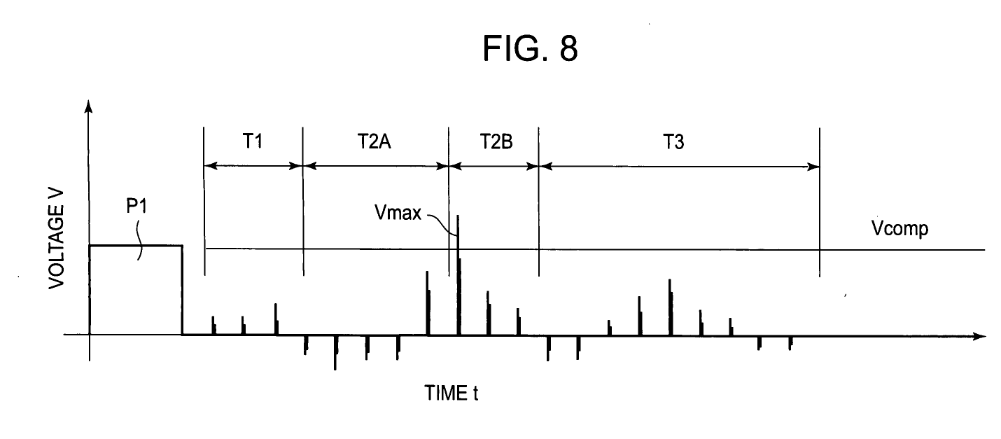

In FIG. 8, the maximum value Vmax of the induced signal VRs exceeding the reference threshold voltage Vcomp is detected only in the third section T2B, and a pattern (0, 0, 1, 0) is obtained. Since the rotor 202 having a large extra driving force is rotated at a high speed, the generation time point of the induced signal VRs exceeding the reference threshold voltage Vcomp becomes earlier. The induced signal VRs is early generated in the case of FIG. 7 as compared with the case of FIG. 8. FIG. 8 illustrates the rotation state having the extra driving force. That is, FIG. 8 illustrates the rotation state in which the extra driving force is small and rotation margin is high.

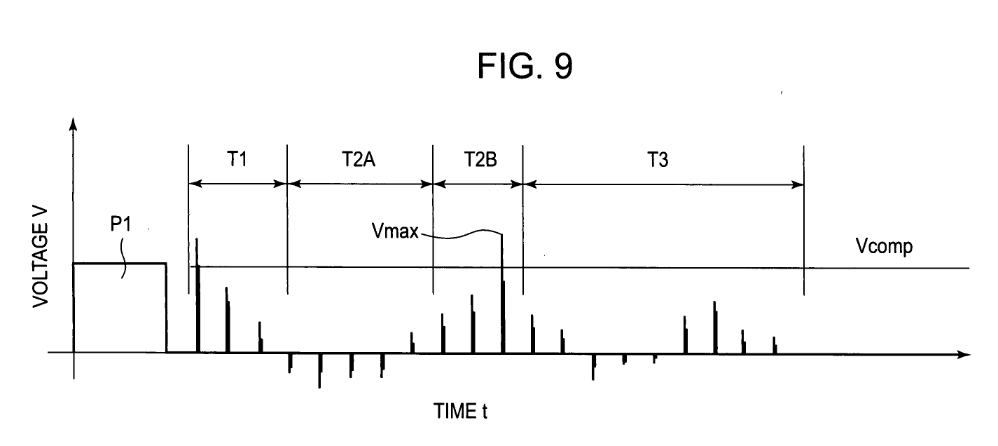

In FIG. 9, the maximum value Vmax of the induced signal VRs exceeding the reference threshold voltage Vcomp is detected only in the first section and the third section T2B, and a pattern (1, 0, 1, 0) is obtained. Such a case represents a rotation state having no extra driving force.

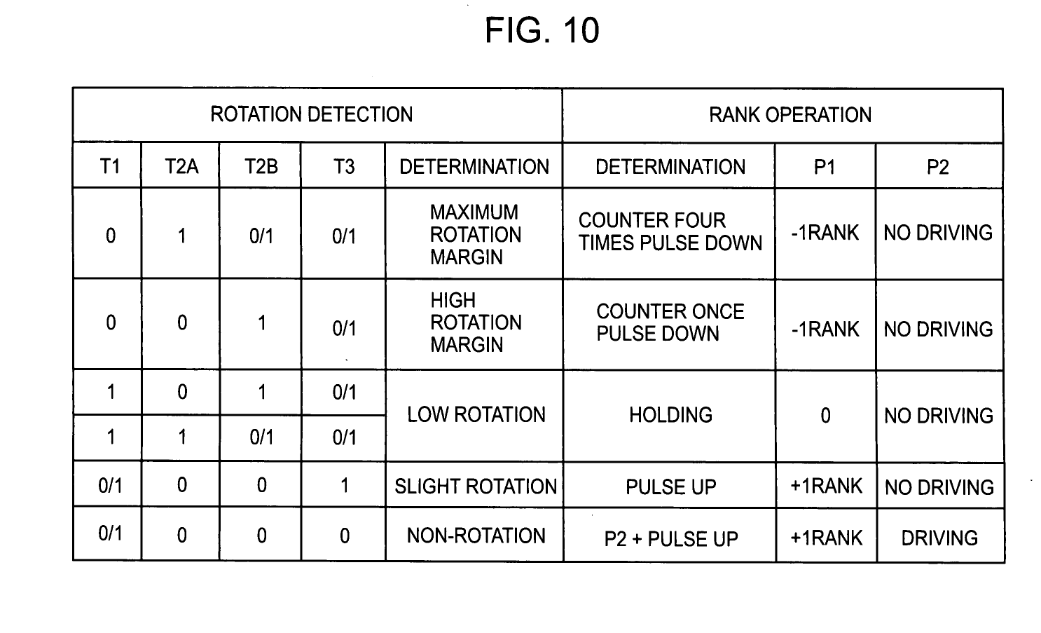

FIG. 10 is a determination chart illustrating the operations according to another embodiment of the invention, which illustrates the relationship between the pattern (T1, T2A, T2B and T3), the degree of rotation margin or the determination result of a rotation state representing the rotation or non-rotation, and pulse control (rank operation) of maintaining or changing the rank of a driving pulse based on the determination result.

When the pattern (0, 1, 0, 0) of FIG. 7 has been generated, the control circuit 103 determines that the rotation margin is maximum (rotation state in which the extra driving force is larger than a predetermined value) as illustrated in FIG. 10. A pulse down operation will be described in detail later. However, in the case of the rotation state in which the extra driving force is large, the control circuit 103 performs a counting operation by weighting the number 1 of times, by which the rotation state having the extra driving force occurs, with the number 4 of times, by which the rotation state having the extra driving force occurs, and adds the counted value to an accumulated counting value.

When the pattern (0, 0, 1, 0) of FIG. 8 has been generated, the control circuit 103 determines that the rotation margin is high (rotation state in which the extra driving force is smaller than the predetermined value) as illustrated in FIG. 10. In the case of the rotation state in which the extra driving force is small, the control circuit 103 performs a counting operation by weighting the number 1 of times, by which the rotation state having the extra driving force occurs, with the number 1 of times, by which the rotation state having the extra driving force occurs, and adds the counted value to an accumulated counting value.

When the sum of the number of times, by which the rotation state having a small extra driving force continuously occurs, and the number of times, by which the rotation state having a large extra driving force continuously occurs, has reached the predetermined value, the control circuit 103 allows the main driving pulse P1 to be down by one rank (pulse down).

Meanwhile, when the pattern (1, 0, 1, 0) of FIG. 9 has been generated, the control circuit 103 determines that low rotation has occurred (rotation state having no extra driving force) as illustrated in FIG. 10. In the case of the rotation state having no extra driving force, the control circuit 103 maintains the energy of the main driving pulse P1 without changing the same.

As described above, according to another embodiment, the number of times, by which the rotation state having the extra driving force occurs, is counted as the number of times of occurrences weighted according to the magnitude of the extra driving force. In the case in which the rotation state having the extra driving force has continuously occurred, when the sum of the number of times of occurrences, which is obtained by weighting the rotation states having the extra driving force, has reached a predetermined number of times (e.g., the number 1 of times in the previous embodiment), the main driving pulse P1 is allowed to be down.

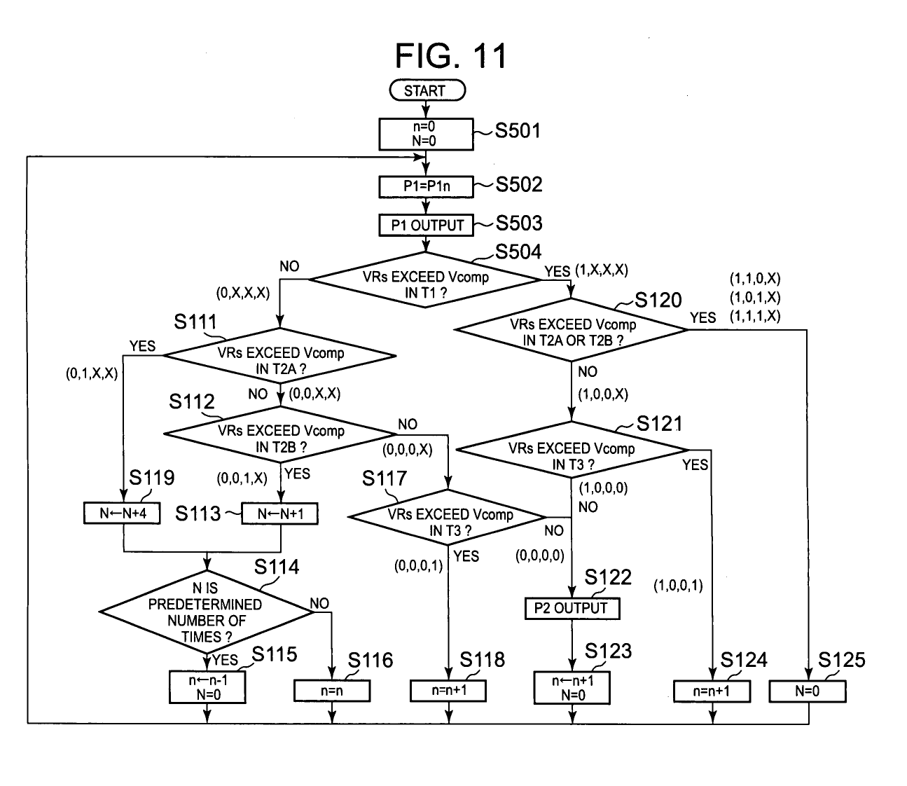

FIG. 11 is a flowchart illustrating the operation according to another embodiment.

Hereinafter, the operation according to another embodiment will be described with reference to FIGS. 1, 2, and 7 to 11.

In FIG. 1, the oscillating circuit 101 generates the reference clock signal with the predetermined frequency, and the divider circuit 102 divides the signal generated by the oscillating circuit 101 to generate the watch signal serving as the reference of the watch, and outputs the watch signal to the control circuit 103.

The control circuit 103 performs the time counting operation by counting the watch signal. First, the control circuit 103 sets the rank “n” of the main driving pulse P1n and the number N of times, by which the rotation state having the extra driving force continuously occurs, to “0” (Step S501 of FIG. 11), and outputs the control signal such that the stepping motor 105 is rotated by the main driving pulse P10 with the minimum pulse width (Steps S502 and S503).

The driving pulse selecting circuit 104 rotates the stepping motor 105 by using the main driving pulse P10 in response to the control signal from the control circuit 103. The stepping motor 105 is rotated by the main driving pulse P10 to rotate the time hands 107, 108 and 110. In this way, when the stepping motor 105 is normally rotated, the current time is displayed at any time on the analog display unit 106 through the time hands 107, 108 and 110.

The control circuit 103 determines whether the rotation detecting circuit 111 has detected the induced signal VRs of the stepping motor 105 exceeding the predetermined reference threshold voltage Vcomp, and determines whether the detection section determining circuit 112 has decided that the detection time t of the induced signal VRs belongs to the first section T1 (i.e., determines whether the induced signal VRs exceeding the reference threshold voltage Vcomp has been detected in the first section T1) (Step S504).

When it is determined that the induced signal VRs exceeding the reference threshold voltage Vcomp has not been detected in the first section T1 in the process step S504 (in the case of a pattern expressed by (0, x, x, x) and the determination value “x” may be “1” or “0” similarly to the previous embodiment), the control circuit 103 determines whether the induced signal VRs exceeding the reference threshold voltage Vcomp has been detected in the second section T2A similarly to the previous method (Step S111).

When it is determined that the induced signal VRs exceeding the reference threshold voltage Vcomp has not been detected in the second section T2A in the process step S111 (in the case of a pattern expressed by (0, 0, x, x)), the control circuit 103 determines whether the induced signal VRs exceeding the reference threshold voltage Vcomp has been detected in the third section T2B similarly to the previous method (Step S112).

When it is determined that the induced signal VRs exceeding the reference threshold voltage Vcomp has been detected in the third section T2B in the process step S112 (in the case of a pattern expressed by (0, 0, 1, x), the case of the rotation state having a small extra driving force, and the case of the high rotation margin of FIGS. 8 and 10), the control circuit 103 adds the number 1 of times, which is weighted, to the number N of times (Step S113). When the number N of times after the addition has reached the predetermined number of times (e.g., the number 1 of times in the previous embodiment) (Step S114), the control circuit 103 allows the energy rank of the main driving pulse P1 to be down by one rank while setting the number N of times to “0”, and then returns to the process step S502 (Step S115).

When the number N of times after the addition has not reached the predetermined number of times in the process step S114, the control circuit 103 returns to the process step S502 without changing the energy rank of the main driving pulse P1 (Step S116).

When it is determined that the induced signal VRs exceeding the reference threshold voltage Vcomp has not been detected in the third section T2B in the process step S112 (in the case of a pattern expressed by (0, 0, 0, x)), and when it is determined that the induced signal VRs exceeding the reference threshold voltage Vcomp has been detected in the fourth section T3 (in the case of a pattern expressed by (0, 0, 0, 1) and the case of the slight rotation of FIG. 10) (Step S117), the control circuit 103 allows the energy rank of the main driving pulse P1 to be up by one rank and then returns to the process step S502 (Step S118).

When it is determined that the induced signal VRs exceeding the reference threshold voltage Vcomp has not been detected in the fourth section T3 in the process step S117 (in the case of a pattern expressed by (0, 0, 0, 0) and the case of the non-rotation of FIG. 10), the control circuit 103 controls the driving pulse selecting circuit 104 such that the stepping motor 105 is driven by the correction driving pulse P2 (Step S122), allows the energy rank of the main driving pulse P1 to be up by one rank while setting the number N of times to “0”, and then returns to the process step S502 (Step S123). In this way, when the rotation state having the extra driving force does not occur, the number N of times is reset to “0”.

When it is determined that the induced signal VRs exceeding the reference threshold voltage Vcomp has been detected in the second section T2A in the process step S111 (in the case of a pattern expressed by (0, 1, x, x), the case of the rotation state having a large extra driving force, and the case of the maximum rotation margin of FIGS. 7 and 10), the control circuit 103 adds the number 4 of times, which is weighted, to the number N of times and proceeds to the process step S114 (Step S119).

Further, in the process steps S119 and S113, the control circuit 103 counts the sum of the number of times, which is obtained by weighting the number of times of occurrences of the rotation state having a small extra driving force, and the number of times, which is obtained by weighting the number of times of occurrences of the rotation state having a large extra driving force, and determines whether the sum has reached the predetermined number of times in the process step S114.

When it is determined that that the induced signal VRs exceeding the reference threshold voltage Vcomp has been detected in the first section T1 in the process step S504 (in the case of a pattern expressed by (1, x, x, x)), the control circuit 103 determines whether the induced signal VRs exceeding the reference threshold voltage Vcomp has been detected in the second section T2A or the third section T2B similarly to the previous method (Step S120).

When it is determined that the induced signal VRs exceeding the reference threshold voltage Vcomp has not been detected in any one of the second section T2A and the third section T2B in the process step S120 (in the case of a pattern expressed by (1, 0, 0, x)), and when it is determined that the induced signal VRs exceeding the reference threshold voltage Vcomp has also not been detected in the fourth section T3 (in the case of a pattern expressed by (1, 0, 0, 0) and the case of the non-rotation having no extra driving force of FIG. 10) (Step S121), the control circuit 103 controls the driving pulse selecting circuit 104 such that the stepping motor 105 is driven by the correction driving pulse P2, allows the energy rank of the main driving pulse P1 to be up by one rank while setting the number N of times to “0”, and then returns to the process step S502 (Steps S122 and S123).

When it is determined that that the induced signal VRs exceeding the reference threshold voltage Vcomp has been detected in the fourth section T3 in the process step S121 (in the case of a pattern expressed by (1, 0, 0, 1) and the case of the slight rotation having no extra driving force of FIG. 10), the control circuit 103 allows the energy rank of the main driving pulse P1 to be up by one rank and then returns to the process step S502 (Step S124).

Further, when it is determined that the induced signal VRs exceeding the reference threshold voltage Vcomp has been detected in at least one of the second section T2A and the third section T2B in the process step S120 (in the case of a pattern expressed by (1, 1, 0, x), (1, 0, 1, x) or (1, 1, 1, x), and the case of the low rotation having no extra driving force of FIG. 10), the control circuit 103 sets the number N of times to “0” because the rotation state having the extra driving force does not continuously occur, and then returns to the process step S502 (Step S125).

As described above, according to the another embodiment, the number of times of occurrences of the rotation state having the extra driving force of the main driving pulse P1 is counted as the number of times of occurrences weighted according to the magnitude of the extra driving force. Further, in the case in which the rotation state having the extra driving force has continuously occurred, when the sum of the number of times of occurrences, which is obtained by weighting the rotation states having the extra driving force, has reached the predetermined number of times (e.g., the number 1 of times), the main driving pulse P1 is allowed to be down, so that the wasteful consumption of energy can be prevented when the continuous load is reduced.

In addition, in the analog electronic watch, when the continuous load such as the calendar load is reduced, the wasteful consumption of energy can be prevented.

Furthermore, in the case of the rotation state having a small extra driving force, since the control circuit 103 carefully determines such that the rank-down operation is performed when the number of times by which the rotation state actually occurs is high, the occurrence of the non-rotation after the rank-down operation can be prevented. Moreover, when the extra driving force is large, since the rank-down operation is quickly performed, power saving can be achieved. In addition, even when the state having a large extra driving force exists together with the state having a small extra driving force, a problem, in which the rank-down operation is suddenly performed, can be prevented and the rank-down operation can be appropriately performed.

Further, since the rank-down operation is performed according to the magnitude of the extra driving force, it is possible to prevent the rank-down operation from being not performed for a long time when a load has suddenly occurred, and to prevent the wasteful consumption of power.

Furthermore, since it is possible to realize low-consumption driving due to the reduction of the rank-down period after the load suddenly occurs, and avoidance of the problem caused by the rank-down when the load suddenly occurs, smooth engagement of gears can be achieved in a train wheel sub-load and the like, the rank-down operation can be prevented from being performed when a load is instantaneously released, and the hands can be stably driven.

Herein, in the case of the rotation state having a large extra driving force, the control means may perform a counting operation through weighting in which the number of times of occurrences is increased, as compared with the case of the rotation state having a small extra driving force. In the case in which the rotation state having the extra driving force has continuously occurred, when the sum of the number of times of occurrences, which is obtained by weighting the rotation states having the extra driving force, has reached the first number of times, the control means may allow the main driving pulse to be down.

In addition, even in the another embodiment, as the number of times of occurrences, which is obtained by weighting the number of times of occurrences of the rotation state having the extra driving force of the main driving pulse P1 according to the magnitude of the extra driving force, the number 4 of times is set in the case of the maximum rotation margin and the number 1 of times is set in the case of the high rotation margin. However, in the case of the maximum rotation margin, the number of times of occurrences larger than the number 4 of times may be set. In the case of the maximum rotation margin, the pulse down operation may be performed more quickly.

Furthermore, the detection section T may be divided into a plurality of sections, for example, the first section T1 immediately after driving by the main driving pulse, the second section T2A after the first section T1, the third section T2B after the second section T2A, and the fourth section T3 after the third section T2B. In the normal load state, the first section T1 serves as a section for determining a rotation state of the rotor 202 in the forward direction and an initial rotation state of the rotor 202 in the backward direction in the third quadrant III of the space employing the rotor 202 as the center, the second section T2A and the third section T2B serve as sections for determining the initial rotation state of the rotor 202 in the backward direction in the third quadrant III, and the fourth section T3 serves as a section for determining a rotation state after the initial rotation of the rotor 202 in the backward direction in the third quadrant III. The control means may determine the extra driving force based on the patterns of the induced signal VRs detected in the first to fourth sections T1 to T3. In the case in which the rotation state having the extra driving force has continuously occurred, when the sum of the number of times of occurrences, which is obtained by weighting the pattern representing the extra driving force is small and the pattern representing the extra driving force is large, has reached the predetermined number of times (e.g., the number 1 of times), the control means may allow the main driving pulse P1 to be down.

In addition, the pattern representing that the extra driving force is small may be expressed by (0, 0, 1, x) and the pattern representing that the extra driving force is large may be expressed by (0, 1, x, x).

Further, according to the previous embodiments, since the energy of each main driving pulse P1 is changed, the pulse widths thereof may be different from each other. However, the driving energy can be changed by changing a pulse voltage and the like.

Furthermore, the calendar load has been described as an example of the continuous load reduced after being continued for a predetermined time. However, it is possible to use various types of loads such as loads which cause a predetermined operation in a character provided in the display unit to inform a predetermined time.

In addition, the electronic watch has been described as an application of the stepping motor. However, the invention can be applied to an electronic apparatus using a motor.

The stepping motor control circuit according to the invention can be applied to various electronic apparatuses using the stepping motor.

Moreover, the electronic watch according to the invention can be applied to various analog electronic watches including an analog electronic wrist watch having a calendar function, and an analog electronic watch having various calendar functions such as an analog electronic table clock having a calendar function.

What is claimed is:

1. A stepping motor control circuit comprising:
a rotation detecting means which detects an induced signal generated by rotation of a rotor of a stepping motor, and detects a rotation state of the stepping motor according to whether the induced signal exceeds a predetermined reference threshold voltage in a predetermined detection section; and
a control means which controls driving of the stepping motor by using any one of a plurality of main driving pulses having energies different from each other or a correction driving pulse having energy higher than energy of each main driving pulse according to a detection result of the rotation detecting means,
wherein the control means allows the main driving pulse to be down when a rotation state, in which an extra driving force of the main driving pulse is small, continuously occurs by a predetermined first number of times, and allows the main driving pulse to be down even if the rotation state having a small extra driving force does not continuously occur by the predetermined first number of times when a rotation state having a large extra driving force is large has occurred under a condition in which at least the rotation state having the small extra driving force continuously occurs.

2. A stepping motor control circuit according to claim 1, wherein, if the rotation state having the large extra driving force has occurred under the condition in which at least the rotation state having the small extra driving force continuously occurs, the control means allows the main driving pulse to be down when a sum of a number of times by which the rotation state having the small extra driving force continuously occurs, and a number of times by which the rotation state having the large extra driving force continuously occurs becomes a second number of times smaller than the first number of times.

3. A stepping motor control circuit according to claim 1, wherein, the detection section is divided into a plurality of sections, and the control means determines magnitude of the extra driving force based on a pattern of the induced signal detected by the rotation detecting means in the plurality of sections, allows the main driving pulse to be down when a pattern representing that the extra driving force is small is continuously generated by the predetermined first number of times, and allows the main driving pulse to be down even if the pattern representing that the extra driving force is small is not continuously generated by the predetermined first number of times when a pattern representing that the extra driving force is large has been generated under a condition in which at least the pattern representing that the extra driving force is small is continuously generated.

4. A stepping motor control circuit according to claim 2, wherein, the detection section is divided into a plurality of sections, and the control means determines magnitude of the extra driving force based on a pattern of the induced signal detected by the rotation detecting means in the plurality of sections, allows the main driving pulse to be down when a pattern representing that the extra driving force is small is continuously generated by the predetermined first number of times, and allows the main driving pulse to be down even if the pattern representing that the extra driving force is small is not continuously generated by the predetermined first number of times when a pattern representing that the extra driving force is large has been generated under a condition in which at least the pattern representing that the extra driving force is small is continuously generated.

5. A stepping motor control circuit according to claim 3, wherein, the detection section is divided into a first section immediately after driving by the main driving pulse, a second section after the first section and a third section after the second section, and, in a normal load state, the first section serves as a section for determining a rotation state of the rotor in a forward direction and an initial rotation state of the rotor in a backward direction in a third quadrant of a space employing the rotor as a center, the second section serves as a section for determining the initial rotation state of the rotor in the backward direction in the third quadrant, and the third section serves as a section for determining a rotation state after the initial rotation of the rotor in the backward direction in the third quadrant,
wherein the control means allows the main driving pulse to be down when the pattern representing that the extra driving force is small is continuously generated by the predetermined first number of times, and allows the main driving pulse to be down even if the pattern representing that the extra driving force is small is not continuously generated by the predetermined first number of times when the pattern representing that the extra driving force is large has been generated under the condition in which at least the pattern representing that the extra driving force is small is continuously generated.

6. A stepping motor control circuit according to claim 4, wherein, the detection section is divided into a first section immediately after driving by the main driving pulse, a second section after the first section and a third section after the second section, and, in a normal load state, the first section serves as a section for determining a rotation state of the rotor in a forward direction and an initial rotation state of the rotor in a backward direction in a third quadrant of a space employing the rotor as a center, the second section serves as a section for determining the initial rotation state of the rotor in the backward direction in the third quadrant, and the third section serves as a section for determining a rotation state after the initial rotation of the rotor in the backward direction in the third quadrant,
wherein the control means allows the main driving pulse to be down when the pattern representing that the extra driving force is small is continuously generated by the predetermined first number of times, and allows the main driving pulse to be down even if the pattern representing that the extra driving force is small is not continuously generated by the predetermined first number of times when the pattern representing that the extra driving force is large has been generated under the condition in which at least the pattern representing that the extra driving force is small is continuously generated.

7. A stepping motor control circuit according to claim 5, wherein the pattern representing that the extra driving force is small is expressed by (1, 1, 1) and the pattern representing that the extra driving force is large is expressed by (1, 1, 0).

8. A stepping motor control circuit according to claim 6, wherein the pattern representing that the extra driving force is small is expressed by (1, 1, 1) and the pattern representing that the extra driving force is large is expressed by (1, 1, 0).

9. A stepping motor control circuit according to claim 5, wherein the control means immediately allows the main driving pulse to be down when the pattern expressed by (0, 1, x) representing that the extra driving force is large has been generated.

10. A stepping motor control circuit comprising:
a rotation detecting means which detects an induced signal generated by rotation of a rotor of a stepping motor, and detects a rotation state of the stepping motor according to whether the induced signal exceeds a predetermined reference threshold voltage in a predetermined detection section; and
a control means which controls driving of the stepping motor by using any one of a plurality of main driving pulses having energies different from each other or a correction driving pulse having energy higher than energy of each main driving pulse according to a detection result of the rotation detecting means,
wherein the control means counts a number of times, by which a rotation state having an extra driving force occurs, as a number of times of occurrences weighted according to magnitude of the extra driving force, and allows the main driving pulse to be down when a sum of a number of times of occurrences, which is obtained by weighting the rotation state having the extra driving force, reaches a predetermined number of times in a case in which the rotation state having the extra driving force has continuously occurred.

11. A stepping motor control circuit according to claim 10, wherein the control means performs a counting operation through weighting, in which a number of times of occurrences is increased, with respect to a rotation state having a large extra driving force occurs as compared with a rotation state having a small extra driving force, and allows the main driving pulse to be down when a sum of a number of times of occurrences, which is obtained by weighting the rotation state having the extra driving force, reaches the predetermined number of times in a case in which the rotation state having the extra driving force has continuously occurred.

12. A stepping motor control circuit according to claim 10, wherein, the detection section is divided into a plurality of sections, and the control means determines the extra driving force based on a pattern of the induced signal detected by the rotation detecting means in the plurality of sections, and allows the main driving pulse to be down when a sum of a number of times of occurrences, which is obtained by weighting a pattern representing that the extra driving force is small and a pattern representing that the extra driving force is large, reaches the predetermined number of times in the case in which the rotation state having the extra driving force has continuously occurred.

13. A stepping motor control circuit according to claim 11, wherein, the detection section is divided into a plurality of sections, and the control means determines the extra driving force based on a pattern of the induced signal detected by the rotation detecting means in the plurality of sections, and allows the main driving pulse to be down when a sum of a number of times of occurrences, which is obtained by weighting a pattern representing that the extra driving force is small and a pattern representing that the extra driving force is large, reaches the predetermined number of times in the case in which the rotation state having the extra driving force has continuously occurred.

14. A stepping motor control circuit according to claim 12, wherein, the detection section is divided into a first section immediately after driving by the main driving pulse, a second section after the first section, a third section after the second section, and a fourth section after the third section, and, in a normal load state, the first section serves as a section for determining a rotation state of the rotor in a forward direction and an initial rotation state of the rotor in a backward direction in a third quadrant of a space employing the rotor as a center, the second section and the third section serve as sections for determining the initial rotation state of the rotor in the backward direction in the third quadrant, and the fourth section serves as a section for determining a rotation state after the initial rotation of the rotor in the backward direction in the third quadrant,
wherein the control means determines the extra driving force based on the pattern of the induced signal detected by the rotation detecting means in the first to fourth sections, and allows the main driving pulse to be down when the sum of the number of times of occurrences, which is obtained by weighting the pattern representing that the extra driving force is small and the pattern representing that the extra driving force is large, reaches the predetermined number of times in the case in which the rotation state having the extra driving force has continuously occurred.

15. A stepping motor control circuit according to claim 13, wherein, the detection section is divided into a first section immediately after driving by the main driving pulse, a second section after the first section, a third section after the second section, and a fourth section after the third section, and, in a normal load state, the first section serves as a section for determining a rotation state of the rotor in a forward direction and an initial rotation state of the rotor in a backward direction in a third quadrant of a space employing the rotor as a center, the second section and the third section serve as sections for determining the initial rotation state of the rotor in the backward direction in the third quadrant, and the fourth section serves as a section for determining a rotation state after the initial rotation of the rotor in the backward direction in the third quadrant,
wherein the control means determines the extra driving force based on the pattern of the induced signal detected by the rotation detecting means in the first to fourth sections, and allows the main driving pulse to be down when the sum of the number of times of occurrences, which is obtained by weighting the pattern representing that the extra driving force is small and the pattern representing that the extra driving force is large, reaches the predetermined number of times in the case in which the rotation state having the extra driving force has continuously occurred.

16. A stepping motor control circuit according to claim 14, wherein the pattern representing that the extra driving force is small is expressed by (0, 0, 1, x) and the pattern representing that the extra driving force is large is expressed by (0, 1, x, x).

17. An analog electronic watch including a stepping motor for rotating time hands and a stepping motor control circuit for controlling the stepping motor, wherein the stepping motor control circuit according to claim 1 is used as the stepping motor control circuit.

18. An analog electronic watch including a stepping motor for rotating time hands and a stepping motor control circuit for controlling the stepping motor, wherein the stepping motor control circuit according to claim 10 is used as the stepping motor control circuit.

19. An analog electronic watch according to claim 17, further comprising a date indicator for displaying dates, wherein a period for which the stepping motor drives the date indicator represents a rotation state in which an extra driving force is small, and a period after the driving of the date indicator is completed represents a rotation state in which the extra driving force is large.

20. An analog electronic watch according to claim 18, further comprising a date indicator for displaying dates, wherein a period for which the stepping motor drives the date indicator represents a rotation state in which an extra driving force is small, and a period after the driving of the date indicator is completed represents a rotation state in which the extra driving force is large.
